(19) United States
(12) Patent Application Publication
(10) Pub. No.: US 2021/0078198 A1
(43) Pub. Date: Mar. 18, 2021

(54) APPLICATION DEVICE

(71) Applicant: HOMAG GMBH, Schopfloch (DE)

(72) Inventor: Volker SCHMIEDER, Mössingen (DE)

(21) Appl. No.: 16/613,338

(22) PCT Filed: May 14, 2018
(86) PCT No.: PCT/EP2018/062356

§ 371 Date: Nov. 13, 2019

(30) Foreign Application Priority Data
May 18, 2017 (DE) 10 2017 208 422.7

(51) Int. Cl. B27G 11/02; B27D 5/00

(52) U.S. Cl. CPC B27G 11/02; B27M 1/08; B27D 5/006; B27D 5/003

(57) ABSTRACT

The invention relates to an application device, in particular for planar or bar-shaped workpieces of wood, comprising a device for applying a strip or an adhesive to an adhesive bonding surface of the workpiece, in particular for the adhesive bonding of the workpiece to an element to be adhesively bonded, the application device being of modular design, having a number of sub-devices for performing partial process steps.

### TECHNICAL FIELD

The invention relates to an application device, in particular for board-shaped and/or bar-shaped workpieces from lumber.

### PRIOR ART

Machining device such as in particular planing devices for lumber workpieces are known in the prior art. Board-shaped or bar-shaped workpieces from lumber are usually planed and, on account thereof, contoured. Board-shaped workpieces herein tend to be flat elongate workpieces having an extent in the width direction that is larger by a multiple than the extent in the depth or thickness direction, respectively. Furthermore, bar-shaped workpieces tend to be elongate workpiece having an extent in the width direction that corresponds approximately to an extent in the depth or thickness direction, respectively.

Such planing devices plane the workpieces on at least one side along an advancing direction along which the workpieces are transported on tools of the planing device. After the planing, the workpieces are retrieved from the planing device, usually by an operative, stored, and optionally fed to a further production or processing step, respectively, on another downstream device again by an operative. The planed workpieces herein are potentially damaged or incorrectly fed to the further machining device, this leading to rejects and thus to increased costs which is to be avoided.

It is also possible for the machined workpieces after the contouring or after partial contouring to be subsequently further machined. To this end, it is necessary for a suitable device which is capable of being set according to the requirement to be provided. This includes, inter alia, the application of a tape or of an adhesive, in particular for adhesively bonding the workpiece to an element to be adhesively bonded.

### Disclosure of the Invention, Object, Achievement, Advantages

It is the object of the present invention to achieve an application device which is improved in comparison to the prior art and is capable of being universally adapted and set to the requirement. It is also the object to achieve a method for the application.

This object in terms of the application device is achieved by the features of claim 1.

One exemplary embodiment of the invention relates to an application device, in particular for board-shaped or bar-shaped workpieces from lumber, having a device for applying a tape or an adhesive to an adhesive-bonding face of the workpiece, in particular for adhesively bonding the workpiece to an element to be adhesively bonded, wherein the application device is of modular configuration, having a number of sub- devices for carrying out process sub-steps. Adapting the application device to the respective requirement for treating the workpieces is advantageously possible on account of the modular design embodiment.

It is advantageous when an adhesive tape is applied as the tape, and or an adhesive tape as the adhesive and/or a liquid adhesive and/or pasty adhesive are/is applied. Adhesive bonding can thus take place in a simple and advantageous manner, or another tape can be applied for other purposes, for example for covering, or for visual reasons.

It is also advantageous when the adhesive tape is a double-sided adhesive tape having two mutually opposite adhesive sides, which by way of one adhesive side is adhesively bonded to the adhesive-bonding face of the workpiece, wherein the other adhesive side is available for adhesively bonding an element to be adhesively bonded. Additional adhesive can thus be dispensed with on account thereof.

It is also advantageous when the adhesive tape is a one-sided adhesive tape having one adhesive side and one non-adhesive side, which by way of the non-adhesive side is adhesively bonded to the adhesive-bonding face of the workpiece by means of a previously applied adhesive, wherein the adhesive side is available for adhesively bonding an element to be adhesively bonded. Simple adhesive bonding can also be achieved on account thereof.

It is likewise advantageous that a cleaning device for cleaning the workpiece or at least the adhesive-bonding face of the workpiece is provided. On account thereof, cleaning of the adhesive-bonding face and/or other regions of the workpiece can take place prior to the adhesive bonding. The adhesive bond is improved on account thereof, because the adhesive or the adhesive tape is applied to an adhesive bonding face that is no longer contaminated.

It is expedient herein when the cleaning device is configured having a blower device and/or having a brush device. Dust, shavings, etc., which have accumulated in the preceding machining, for example, can thus be removed.

It is also advantageous when a router device is provided by means of which a surface or a surface coating of a workpiece can be removed, in particular only in regions, so as to clear a surface region to be adhesively bonded or coated, or an adhesive-bonding face. A workpiece that potentially may have been otherwise coated can be used, for example, and in regions be cleared of the coating by way of such a router device, so as to then be able to carry out an above-described application of a tape, an adhesive, or the like, on the cleared surface region, for example. For example, the coating can be a previously applied lacquer which does not have to be optimal for adhesive bonding such that the lacquer can be locally removed so as to generate a surface which is better suitable for adhesive bonding.

The router device herein can be integrated in the cleaning device or be configured so as to be separate from the latter. The workpiece can advantageously first be routed and then cleaned, or alternatively first be cleaned and then routed.

It is also advantageous when the blower device generates a gas or air flow which is directed onto the workpiece, in particular onto the adhesive-bonding face of the workpiece. Desired local cleaning is achieved on account thereof.

It can also be advantageous when the gas or air flow is capable of being temperature-controlled, such as heated, by means of a temperature control device. On account thereof, drying and/or preheating of the workpiece can simultaneously take place.

It is furthermore expedient when the brush device has at least one brush which at a relative speed between the brush and the workpiece cleans the latter by brushing. Heavy dirt or persistent dirt can also be removed on account thereof.

It can be advantageous herein when the at least one brush of the brush device performs a translatory and/or rotary movement. A movement relative to the workpiece is thus enabled by virtue of the movement of the brushes, this being advantageous in terms of the removal of dust or dirt.

It is furthermore advantageous when a coating device for applying a coat of at least one coating material such as a primer, a base coat, a lacquer, a pretreatment agent, a wood protection agent and/or a cleaning agent and/or a liquid adhesive and/or a pasty adhesive is provided. On account thereof, different materials for treating the workpiece can be applied.

It is also advantageous when the coating device applies the coat of the at least one coating material to the workpiece by means of at least one nozzle, one roll, roller, etc.

It is also advantageous when a drying device for drying the at least one applied coat of coating material is provided. The drying device herein can be independent of the lower device or be configured conjointly with the latter, or the drying device and the blower device are the same device which are used for different purposes or operational situations, respectively.

It is also particularly expedient when the drying device has a blower nozzle, a heater device, an infrared heater device, wherein the blower nozzle is provided for blowing by means of optionally heated air or gas.

It is likewise expedient when a device for guiding and/or aligning the workpiece is provided. Said device ensures that the workpiece can be treated in a positionally correct manner so that the application or the coating is performed where this is desired on the workpiece.

It is also advantageous when a transport device for transporting the workpiece is provided. A defined transportation of the workpiece past the respective devices can take place on account thereof.

It is also advantageous when the transportation of the workpiece takes place along the device for guiding and/or aligning the workpiece. A defined guided movement of the workpiece in the transporting direction is thus performed.

The transport device preferably has transport rolls, at least one transport chain and/or at least one transport belt. Problem-free transporting of the workpiece can thus be performed.

It is also advantageous when a cross-cut device for cross-cutting or cutting-to-length, respectively, the tape or the adhesive tape is provided. On account thereof, the tape or adhesive tape can preferably be cut off or cut to length in a defined manner at the end of the workpiece such that transition-free or gap-free adhesive bonding can be performed.

It is also advantageous when the cross-cut device cross-cuts or cuts-to-length, respectively, the tape at the end of the workpiece.

It is also advantageous when a positioning unit and/or guide unit for placing the tape and/or the adhesive tape on the workpiece is provided for the tape and/or the adhesive tape. A defined application can be performed on account thereof.

It is furthermore also advantageous when at least some of the modules or the modules are disposed in a closed chamber region which is surrounded by a casing. Contamination and a risk to personnel is thus avoided.

It is also advantageous when a device by means of which the ambient conditions within the casing, such as the temperature and/or the air humidity, for example, are capable of being set is provided. The conditions can thus be adapted to the workpiece, said conditions facilitating machining, for example. For example, the temperature can thus be increased and the air humidity be reduced for drying.

This object in terms of the method is achieved by the features of claim 24.

One exemplary embodiment of the invention relates to a method for applying a tape or an adhesive to an adhesive-bonding face of a workpiece, in particular for adhesively bonding the workpiece to an element to be adhesively bonded, by way of an application device according to the invention.

Further advantageous embodiments are described by the subsequent description of figures and by the dependent claims.

### BRIEF DESCRIPTION OF THE FIGURE OF THE DRAWING

The invention, based on at least one exemplary embodiment, will be explained in more detail hereunder by means of the figure of the drawing in which:

FIG. 1 shows a schematic view of an application device according to the invention.

### PREFERRED EMBODIMENT OF THE INVENTION

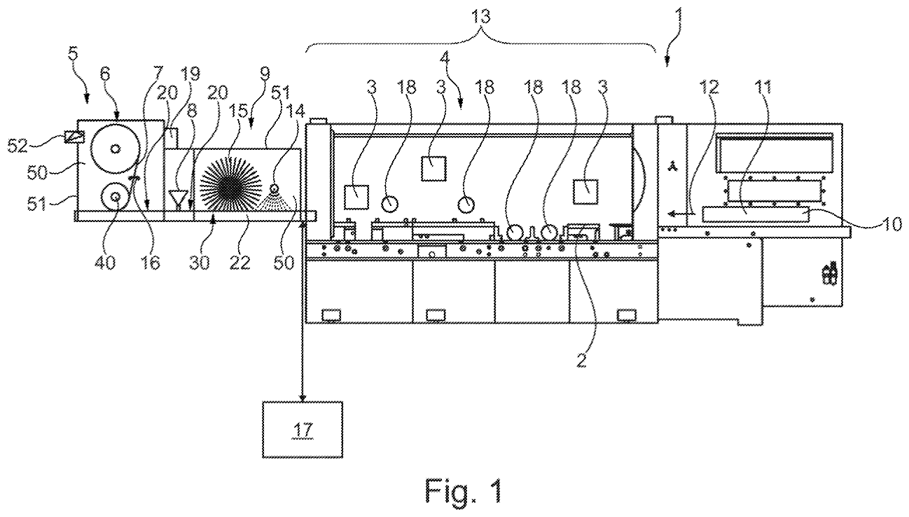

FIG. 1 in a schematic illustration shows a machining device 1, in particular for board-shaped or bar-shaped workpieces 10, in particular from lumber. Board-shaped workpieces 10 herein tend to be flat elongate workpieces 10 having an extent in the width direction that is larger by a multiple than the extent in the depth or thickness direction, respectively. Workpieces 10 that tend to be bar-shaped such as, strips for windows or door frames, etc., which tend to be configured as elongate workpieces 10, having an extent in the width direction that corresponds approximately to an extent in the depth or thickness direction, respectively, can also be processed. The bar-shaped workpieces 10 in the longitudinal direction are typically longer than in the width direction and/or in the depth direction. The workpieces are preferably from solid lumber or from a lumber-like material. It is particularly preferable herein when the workpieces are bar-shaped workpieces, in particular for the construction of windows. The workpieces are preferably approximately up to 300 mm in width and approximately up to 150 mm in thickness.

The machining device 1 in one exemplary embodiment is equipped with a transport device 2 for transporting workpieces 10, wherein the transport device 2 optionally has holding means for holding the workpiece 10 during transportation and/or during machining of at least one of the lateral faces 11 of the workpiece 10. On account thereof, the respective workpiece 10 can be transported through the machining device 1 and be advantageously held for subtractive machining. In order for all lateral faces 11 to be machined, a changeover of the holding means can also be provided.

The transport device 2 advantageously has rolls 18 which transport workpiece 10 in the transporting direction. Said rolls 18 preferably lie above and/or below and preferably act vertically on a workpiece. Laterally disposed rolls 18 which preferably act horizontally are also advantageously provided. Alternatively or additionally to the rolls 18, other transporting means such as a transport belt, etc., can also be provided.

Alternatively, the transport device 2 can also transport the at least one tool 3, or both the workpiece 10 as well as at least one tool 3, respectively.

The transport device 2 on account thereof generates a relative movement between the workpiece 10 and the at least one tool 3 for machining the workpiece 10 by way of the at least one tool 3.

The machining device 1 accordingly has at least one tool 3 for the subtractive contouring or machining, respectively, of the workpiece 10. The machining of the workpiece 10 herein can take place on up to four lateral faces 11, for example by means of a planing device, a four-side molder and/or trenching device 4, a router device, and/or a sanding device, which have/has various tools 3 for machining the desired lateral faces 11 of the workpiece 10.

It can be seen in FIG. 1 that a device 5 for applying material to the workpiece 10, thus an application device 5, is disposed downstream of the at least one tool 3 for contouring.

The at least one application device 5 is provided so as to be optionally independent of the machining device 1 and advantageously so as to be disposed downstream of the latter.

The application device 5, in particular for board-shaped or bar-shaped workpieces 10 from lumber or else other materials, or from a material composition, is provided with a device for applying a tape 7 or an adhesive to an adhesive-bonding face of the workpiece and is configured, for example, as a tape application device 6. Said application device 5 preferably serves in particular for adhesively bonding the workpiece 10 to an element to be adhesively bonded, wherein the application device 5 is preferably of modular configuration, having a number of sub-devices for carrying out process sub-steps. A tape 7 and/or an adhesive tape can be applied to the workpiece 10 by means of the tape application device 6, and/or an adhesive tape as an adhesive and/or a liquid adhesive and/or pasty adhesive can be applied.

The adhesive tape is preferably a double-sided adhesive tape having two mutually opposite adhesive sides, which by way of one adhesive side is adhesively bonded to the adhesive-bonding face of the workpiece 10, wherein the other adhesive side is available for adhesively bonding an element to be adhesively bonded.

The adhesive tape can also be a one-sided adhesive tape having one adhesive side and one non-adhesive side, which by way of the non-adhesive side is adhesively bonded to the adhesive-bonding face of the workpiece by means of a previously applied adhesive, wherein the adhesive side is available for adhesively bonding an element to be adhesively bonded.

It can also be seen in FIG. 1 that a cleaning device 9 for cleaning the workpiece 10 or at least the adhesive-bonding face of the workpiece 10 is provided. The cleaning device 9 is configured having a blower device such as the blower nozzle 14, and/or having a brush device 15. The blower device 14 advantageously generates a gas or air flow which is directed onto the workpiece 10, in particular onto the adhesive-bonding face of the workpiece 10. The gas or air flow herein can optionally be capable of being temperature-controlled, such as heated, by means of a temperature control device.

It is also advantageous when the brush device 15 has at least one brush which at a relative speed between the brush and the workpiece 10 cleans the latter by brushing. It is particularly advantageous when the at least one brush of the brush device 15 performs a translatory and/or rotary movement.

Furthermore, a coating device 20 for applying a coat of at least one coating material such as a primer, a base coat, a lacquer, a pretreatment agent, a wood protection agent and/or a cleaning agent and/or a liquid adhesive and/or pasty adhesive to the workpiece 10 is advantageously provided.

The coating device 20 herein is configured in such a manner that said coating device 20 applies the coat of the at least one coating material to the workpiece 10 by means of at least one nozzle, one roll, roller, etc.

A drying device 8 for drying the at least one applied coat of coating material is advantageously also provided. The drying device herein can have a blower nozzle, a heater device, and/or an infrared heater device, wherein the blower nozzle is provided for blowing by means of optionally heated air or gas. Said heated air can be made available by the drying facilitation device 19.

Furthermore, a device for guiding and/or aligning the workpiece 30 is provided, wherein a transport device 22 for transporting the workpiece 10 is also advantageously provided. The transport device 2 of the planing device 13 herein can be configured so as to be separate from the transport device 22 of the application device 5, or can be connected to or combined with the latter. The transportation of the workpiece 10 herein takes place along the device for guiding and/or aligning 30.

The transport device 22 preferably has transport rolls, at least one transport chain and/or at least one transport belt. The device 30 for guiding and/aligning the workpiece 10 has at least one defined fence for guiding the workpiece 10.

The application device 5 preferably also has a cross-cut device 16 for cross-cutting or cutting-to-length, respectively, the tape or the adhesive tape. The cross-cut device 16 is advantageously configured in such a manner that said cross-cut device 16 cross-cuts or cuts-to-length, respectively, the tape or adhesive tape at the end of the workpiece 10.

A positioning unit and/or guide unit 40 for placing the tape and/or the adhesive tape on the workpiece 10 is also provided for the tape and/or the adhesive tape.

It is also advantageous when at least some of the modules or the modules are disposed in a closed chamber region 50 which is surrounded by a casing 51. A device 52 by means of which the ambient conditions within the casing 51 are capable of being set, such as the temperature and/or the air humidity, for example, can advantageously be provided herein.

The transport device 2 or 22, or a segment of the transport device 2 for the workpiece 10, advantageously transverses in particular also the application device 5 for applying material, and transports the workpiece 10 toward the device 5 for applying material and/or past the application device 5 for applying material, such as the application device 5. On account thereof, the material to be applied can be applied during the movement of the workpiece 10 such that efficient processing can take place. Alternatively, the workpiece 10 can also be brought to a standstill before said workpiece 10 is transported onward and the material is applied.

The device 5 for applying material to the workpiece can be configured as a tape application device 6, or comprise such a tape application device 6. At least one prefabricated tape 7 can advantageously be applied to the workpiece 10 by way of such a tape application device 6. The tape 7 herein can be an adhesive tape or a masking tape or any other tape. As an adhesive tape, said tape can be adhesive on one side or both sides. The tape application device 6 advantageously has a cross-cut device 16 for cross-cutting the tape 7 so as to be able to cut the tape 7 to the required length. The tape 7 can be self-adhesive, for example, and/or an adhesive can also be applied. An adhesive can also be applied independently of the tape 7 or else without a tape 7. Said adhesive can be applied by way of rollers, rolls, sprays, etc., in particular in an upstream device 8 such as in a coating device 8.

Optionally, the device 5 for applying material advantageously has the device 8 by means of which a median such as, for example, a primer, an adhesive, etc., is capable of being applied to the workpiece 10. The medium can be applied by way of rollers, rolls, sprays, etc. Said device 8 is optionally disposed so as to be upstream of the tape application device 6 in the direction 12 of the workpiece flow, or else is provided without such a tape application device 6. On account thereof, an in particular further medium can be applied, in particular pre-applied, prior to the application of a tape, or else without the application of the tape. An adhesive bonding face to which an adhesive or a self-adhesive material is applied can optionally be pre-treated with a wood protection agent or in another manner.

In the case of an exemplary embodiment it is particularly advantageous when an optional drying facilitation device 19 which is preferably configured as a heater and/or a fan, etc., and by means of which the applied material such as, for example a base coat, a primer, etc., can be more rapidly dried by means of the device 8 is also provided. The heat herein can be an air heater, an infrared heater, a heating radiator and/or a hotplate, etc., which accelerate/accelerates the drying of the material on the workpiece. To this end, a fan which transports, for example, hot air to the workpiece in order for the drying to be accelerated can furthermore also be provided.

FIG. 1 furthermore shows that a cleaning device 9 for cleaning the workpiece 10 after said workpiece 10 has been subtractively machined in the machining device or planing device 13 and before said workpiece 10 is provided with material is disposed in the workpiece flow between the machining device or planing device 13 having the tools 3 and the device 5 for applying material. The cleaning device 9 herein can have a blower nozzle 14, a suction device, and/or a brush device 15, etc. For example, the blower nozzle 14 blows air such as, for example, compressed air, onto the workpiece 10 and thus cleans the surface of the workpiece 10 in particular in terms of fine elements such as dust or shavings. The brush device 15 brushes the workpiece and thus cleans the latter, in particular in terms of comparatively coarse elements.

By way of such a machining device it is possible for a method for machining a workpiece 10 in which a workpiece is subtractive contoured in a machining device or a planing device 13 on at least one lateral face 11 and subsequently in the workpiece flow a material is applied to the workpiece 10 by means of the device 5 for applying material on the workpiece 10 to be carried out. This is preferably and optionally performed in a workpiece flow at a substantially continuous transportation of the workpiece 10. Alternatively, a workpiece store 17 in which workpieces 10 can be temporarily stored can be interposed. Said workpiece store 17 can be optional. If said workpiece store 17 is present, workpieces 10 can be stored therein on demand; alternatively, said workpiece store 17 can also be bypassed on demand such that the machined workpieces 10 are conveyed onward directly without any intermediate storage.

In the case of the method it is particularly preferable when cleaning is performed after the contouring of the workpiece 10, in particular before material is applied to the workpiece 10. This enhances the quality of the application of material, in particular the adhesive capability of the material on the workpiece 10 over a comparatively long period of time.

The machining device or the planing device 13, the optional cleaning device 9, and the device 5 for applying material accordingly form a unit in which the transport device 2 transports the workpiece 10 to be machined and to be provided with material in particular through the entire machining device. An operative places the workpiece 10 into the machining device 1 at the infeed side and retrieves said workpiece 10 again at the outfeed side, said workpiece 10 first having been contoured and provided with material. However, in principle this can also be performed in an automated manner. No intervention in the normal production process takes place between the contouring and the provision with material.

Alternatively however, an operative can also intervene between at least individual operative steps and retrieve and/or add workpieces from or to the process, respectively.

The application of material, thus of adhesive tapes and/or of masking tapes, for example, can preferably take place in pre-cut rabbets of the workpiece 10.

The transport device 2 can be embodied so as to be contiguous or in segments for the respective transportation through the machining device or planing device 13, the cleaning device 9, the workpiece store 17, and/or the device 5 for applying material. To this end, the provided rolls 18 can be disposed in a corresponding manner so as to be able to transport a workpiece 10 through the machining device, for example.

The machining device 1 and/or the cleaning device 9 and/or the device 5 for applying material are/is preferably disposed in a protected room or in a protective housing, optionally while generating defined ambient conditions, in particular in terms of temperature, air humidity, etc.

An adhesive tape according to the invention can be, for example, a polyethylene (PE) foam adhesive tape and/or an acrylate foam adhesive tape or a PE film adhesive tape.

However, the workpieces 10 are preferably and optionally not provided with an edge tape or any other surface coating which is understood to be a lamination and configures a permanent usable surface. The material applied according to the invention is preferably an adhesive tape, and adhesive, and a base coat/primer, or similar, see above.

It is also preferable when the workpiece 10 can optionally be machined such as planed and/or routed on all sides, and/or the workpiece 10 can be provided with the material to be applied on all sides. All sides herein means in particular the four long sides of the workpiece 10 and preferably in particular not the two mutually opposite end sides of the workpiece 10.

A router device can preferably be integrated in the cleaning device 9, or the router device can also be provided additionally or separately, respectively, to the cleaning device 9.

The cleaning device 9 can also perform cleaning of the workpiece with a fluid such as, for example, a fluid such as gas and/or a liquid that is sprayed or squirted on. The applied fluid herein can also have an antistatic effect on the surface of the workpiece. Accordingly, the cleaning device 9 can be equipped with a spray nozzle, a squirt nozzle, or similar, so as to be able to apply the fluid to the workpiece.

The application device 5 can be configured so as to be integral to the planing device 13, or the application device 5 and the planing device 13 can be configured as independent devices.

### LIST OF REFERENCE SIGNS

1 Machining device
2 Transport device
3 Tool
4 Trenching device
5 Application device
6 Tape application device
7 Tape
8 Device
9 Cleaning device
10 Workpiece
11 Lateral face
12 Direction
13 Machining device, planing device
14 Blower nozzle/blower device
15 Brush device
16 Cross-cut device
17 Workpiece storage device
18 Roll
19 Drying facilitation device/drying device/temperature control device
20 Coating device
22 Transport device
30 Device for guiding and/or aligning
40 Positioning unit, guide unit
50 Chamber region
51 Casing
52 Device for setting ambient conditions

1. An application device, in particular for board-shaped or bar-shaped workpieces from lumber, having a device for applying a tape or an adhesive to an adhesive-bonding face of the workpiece, in particular for adhesively bonding the workpiece to an element to be adhesively bonded, wherein the application device is of modular configuration, having a number of sub-devices for carrying out process sub-steps.

2. The application device as claimed in claim 1, wherein an adhesive tape is applied as the tape, and/or an adhesive tape as the adhesive and/or a liquid adhesive and/or pasty adhesive are/is applied.

3. The application device as claimed in claim 2, wherein the adhesive tape is a double-sided adhesive tape having two mutually opposite adhesive sides, which by way of one adhesive side is adhesively bonded to the adhesive-bonding face of the workpiece, wherein the other adhesive side is available for adhesively bonding an element to be adhesively bonded.

4. The application device as claimed in claim 2, wherein the adhesive tape is a one-sided adhesive tape having one adhesive side and one non-adhesive side, which by way of the non-adhesive side is adhesively bonded to the adhesive-bonding face of the workpiece by means of a previously applied adhesive, wherein the adhesive side is available for adhesively bonding an element to be adhesively bonded.

5. The application device as claimed in claim 1, wherein a cleaning device for cleaning the workpiece or at least the adhesive-bonding face of the workpiece is provided.

6. The application device as claimed in claim 5, wherein the cleaning device is configured having a blower device and/or having a brush device.

7. The application device as claimed in claim 1, wherein a router device is provided by means of which a surface or a surface coating of a workpiece can be removed, in particular only in regions, so as to clear a surface region to be adhesively bonded or coated or an adhesive-bonding face.

8. The application device as claimed in claim 6, wherein the blower device generates a gas or air flow which is directed onto the workpiece, in particular onto the adhesive-bonding face of the workpiece.

9. The application device as claimed in claim 8, wherein the gas or air flow is capable of being temperature-controlled, such as heated, by means of a temperature control device.

10. The application device as claimed in claim 6, wherein the brush device has at least one brush which at a relative speed between the brush and the workpiece cleans the latter by brushing.

11. The application device as claimed in claim 10, wherein the at least one brush of the brush device performs a translatory and/or rotary movement.

12. The application device as claimed in claim 1, wherein at least one coating device for applying a coat of at least one coating material such as a primer, a base coat, a lacquer, a pretreatment agent, a wood protection agent and/or a cleaning agent and/or a liquid adhesive and/or a pasty adhesive is provided.

13. The application device as claimed in claim 1, wherein the coating device applies the coat of the at least one coating material to the workpiece by means of at least one nozzle, one roll, roller, etc.

14. The application device as claimed in claim 1, wherein a drying device for drying the at least one applied coat of coating material is provided.

15. The application device as claimed in claim 1, wherein the drying device has a blower nozzle, a heater device, an infrared heater device, wherein the blower nozzle is provided for blowing by means of optionally heated air or gas.

16. The application device as claimed in claim 1, wherein a device for guiding and/or aligning the workpiece is provided.

17. The application device as claimed in claim 1, wherein a transport device for transporting the workpiece is provided.

18. The application device as claimed in claim 17, wherein the transportation of the workpiece takes place along the device for guiding and/or aligning the workpiece.

19. The application device as claimed in claim 17, wherein the transport device has transport rolls, at least one transport chain and/or at least one transport belt and/or at least one transport conveyor.

20. The application device as claimed in claim 1, wherein a cross-cut device for cross-cutting or cutting-to-length, respectively, the tape or the adhesive tape is provided.

21. The application device claimed in claim 1, wherein the cross-cut device cross-cuts or cuts-to-length, respectively, the tape at the end of the workpiece.

22. The application device as claimed in claim 1, wherein a positioning unit and/or guide unit for placing the tape and/or the adhesive tape on the workpiece is provided for the tape and/or the adhesive tape.

23. The application device as claimed in claim 1, wherein at least some of the modules or the modules are disposed in a closed chamber region which is surrounded by a casing.

24. The application device as claimed in claim 1, wherein a device by means of which the ambient conditions within the casing, such as the temperature and/or the air humidity, for example, are capable of being set is provided.

25. A method for applying a tape or an adhesive to an adhesive-bonding face of a workpiece, in particular for adhesively bonding the workpiece to an element to be adhesively bonded, by way of an application device as claimed in claim 1.
